(19) United States
(12) Patent Application Publication
(10) Pub. No.: US 2021/0130606 A1
(43) Pub. Date: May 6, 2021

(54) BIODEGRADEABLE FILM

(71) Applicant: BIO-TEC BIOLOGISCHE NATURVERPACKUNGEN GMBH & CO. KG, Emmerich (DE)

(72) Inventors: Wolfgang Friedek, Bedburg-Hau (DE); Johannes Mathar, GP's-Heerenberg (NL); Thorsten Roloff, Monheim (DE); Harald Schmidt, Emmerich (DE)

(21) Appl. No.: 16/499,965

(22) PCT Filed: Mar. 26, 2018
(86) PCT No.: PCT/EP2018/057670

§ 371 Date: Oct. 1, 2019

(30) Foreign Application Priority Data
Apr. 5, 2017 (DE) 10 2017 003 341.2

(51) Int. Cl. C08L 67/02; B29C 48/00; B29C 48/08; C08J 5/18

(52) U.S. Cl. CPC C08L 67/02; B29C 48/022; B29K 2067/00; C08J 5/18; B29C 48/08

(57) ABSTRACT

A film is shown and described which comprises 10-90 wt. % of a component A and 10-90 wt. % of a component B, based on the sum of the components A and B,
A being a polyhydroxyalkanoate and
B being an aliphatic copolyester composed of at least one diol component and at least one dicarboxylic acid component,
and the film having a total thickness of 1 to 200 μm.

The invention relates to a film and to a method for preparation thereof. The invention further relates to the use of a polymer blend for producing a film. The invention also relates to transport bags.

The pollution of the oceans by plastic waste is a problem that has been known for decades and is still unsolved. Plastic is a significant problem in particular for the animals in the sea. The animals get caught in larger pieces of plastic and confuse small pieces of plastic with food, which they cannot digest. Above all, particularly small plastic parts, which are known as microplastics, are absorbed by animals through food and thus also end up in the human food chain.

Many of the pieces of plastic found in the oceans come from plastics carrier bags (“plastic bags”), such as those used in everyday life, for example for shopping. The terms “plastics material/plastics” and “plastic” are used synonymously in the following.

Recycling, sustainable use of plastics products and cleaning up the oceans are approaches that should contribute to reducing the amount of plastic in the oceans. However, the most reliable and most sustainable solution would be to produce plastic products that biodegrade under the natural conditions that exist in the oceans.

The biodegradation of plastics products in natural sea water (salt water) is much more protracted and more problematic than biodegradation in active media such as compost or at higher temperatures, such as those in industrial composting plants. On the one hand, compost has a particularly high concentration of microorganisms involved in degradation. On the other hand, industrial composting plants have precisely controlled conditions (e.g. temperature, oxygen concentration) that ensure optimal biodegradation of the compost. The requirements for plastics products that are biodegradable in the natural conditions of the oceans are thus much higher than for other degradation conditions.

In addition, not only must plastics products have good biodegradability under the natural conditions of the oceans, but they must also have application-specific mechanical properties. For example, transport bags made of plastics material must have sufficient values of tensile strength and elongation at tear to be able to be used as intended in everyday life. Only then can they be considered as a substitute for traditional, non-biodegradable plastic products.

The combination of (a) good biodegradability of a plastics film in seawater on the one hand and (b) good mechanical properties of a plastics film on the other hand turns out to be extremely difficult in practice. Previous attempts to reconcile these two seemingly contradictory properties of a film were only partially successful.

EP 2 913 362 A1 describes a film comprising polyhydroxyalkanoates and polylactides which has improved biodegradation in an environment with microorganisms and at the same time has good storage stability, strength and flexibility. However, biodegradation is not optimized for the particularly demanding degradation conditions in natural seawater.

EP 1 008 629 A1 describes a biodegradable polyester resin comprising 100 parts by weight of an aliphatic polyester resin and 1-200 parts by weight of polycaprolactone. From this polymer mixture, a variety of different, biodegradable products can be produced. However, the biodegradability is not adapted to the particularly demanding degradation conditions in natural seawater.

None of the films described solves the problem of the particular challenge of biodegradation in seawater whilst simultaneously having satisfactory mechanical properties.

Proceeding from the prior art described above, the object of the invention is to provide a film which has a very good biodegradability in seawater and at the same time has excellent mechanical properties. Preferably, the film is intended to decompose into smaller particles after its introduction into seawater, simultaneously with, before or after the onset of biodegradation of the film(s) to form carbon dioxide and water. The invention also aims to provide a film which is particularly suitable for the production of transport bags.

These objects are achieved in whole or in part by the film specified in claim 1, the use specified in claim 24, the product specified in claim 27 and the method specified in claim 30.

Advantageous embodiments of the invention are specified in the dependent claims and are explained in detail below, as is the general inventive concept.

The film according to the invention is characterized in that it contains 10 to 90 wt. % of a component A and 10 to 90 wt. % of a component B, based on the sum of components A and B, component A being a polyhydroxyalkanoate and component B being an aliphatic copolyester composed of at least one diol component and at least one dicarboxylic acid component, and the film having a total thickness of 1 to 200 μm.

Surprisingly, it has been found that the films according to the invention have both outstanding mechanical properties such as high tensile strength and/or high elongation at tear and very good biodegradability in natural seawater.

Without wishing to be bound by any scientific theory, the surprising effect of the invention appears to be due to the particular properties of the combination of components A and B. Extensive experimental studies were required to find suitable components and ratios for components A and B. When polymers other than those defined for components A and B were combined, either the films produced therefrom lacked mechanical properties or the biodegradability of the film in seawater was insufficient. Furthermore, it is indispensable for the biodegradability in seawater and the mechanical properties of the films that the correct ratio of components A and B is selected.

Preferably, the film has at least one of the following mechanical properties:
tensile strength in the dry state in the extrusion direction (MD) of at least 15 MPa according to EN ISO 527;
tensile strength in the dry state transversely to the extrusion direction (TD) of at least 15 MPa according to EN ISO 527;
elongation at tear in the dry state in the extrusion direction (MD) of at least 100% according to EN ISO 527;
elongation at tear in the dry state transversely to the extrusion direction (TD) of at least 100% according to EN ISO 527.

The above-mentioned mechanical properties are preferably determined in accordance with EN ISO 527-3:2003-07.

Advantageously, after introduction into salt water for a period of 12 weeks under controlled test conditions, according to the ASTM D6691-09 method, and after sieving through a sieve having a mesh size of 2.0 mm, the film has a maximum of 30 wt. % of the original dry weight, and/or at least 30% of the organic carbon of the film is, after introduction into salt water, converted into carbon dioxide within 180 days at a temperature of 30±2° C., according to the method ASTM D6691-09.

The measurement of the degradation in salt water under controlled test conditions according to ASTM D6691-09 is preferably carried out on films having a thickness of 1 to 100 μm, in particular 10 to 40 μm, more preferably having a thickness of approximately 20 μm.

According to a preferred embodiment, the film contains 10 to 90 wt. % of a component A and 10 to 90 wt. % of a component B, based on the sum of components A and B, component A being a polyhydroxyalkanoate and component B being an aliphatic copolyester composed of at least one diol component and at least one dicarboxylic acid component, and the film having a total thickness of 1 to 200 μm and at least one of the following mechanical properties:
tensile strength in the dry state in the extrusion direction (MD) of at least 15 MPa according to EN ISO 527;
tensile strength in the dry state transversely to the extrusion direction (TD) of at least 15 MPa according to EN ISO 527;
elongation at tear in the dry state in the extrusion direction (MD) of at least 100% according to EN ISO 527;
elongation at tear in the dry state transversely to the extrusion direction (TD) of at least 100% according to EN ISO 527;

and the film having a maximum of 30 wt. % of the original dry weight after introduction into salt water for a period of 12 weeks under controlled test conditions, according to the method ASTM D6691-09, and after sieving through a sieve having a mesh size of 2.0 mm, and/or at least 30% of the organic carbon of the film being converted to carbon dioxide within 180 days at a temperature of 30±2° C., according to the method ASTM D6691-09, after introduction into salt water.

The film according to the invention contains a component A which is a polyhydroxyalkanoate.

When polyhydroxyalkanoates are mentioned here or elsewhere, this is intended to mean polyesters of hydroxy fatty acids containing monomers having a chain length of at least 4 C atoms, in particular from 4 to 18 C atoms or from 4 to 9 C atoms. Polylactic acid is therefore, for example, not polyhydroxyalkanoate within the meaning of the invention.

Component A can, according to an advantageous embodiment of the invention, be selected from the group consisting of poly(3-hydroxybutanoate), poly(3-hydroxyvalerate), poly(3-hydroxyhexanoate), poly(3-hydroxybutyrate-co-3-valerate), poly(3-hydroxybutyrate-co-3-hexanoate), and mixtures thereof. According to a further advantageous embodiment, component A may be selected from the group consisting of poly(3-hydroxybutyrate-co-3-valerate), poly(3-hydroxybutyrate-co-3-hexanoate), and mixtures thereof. In a particularly preferred embodiment of the invention, component A is poly(3-hydroxybutyrate-co-3-hexanoate).

According to a preferred embodiment of the invention, component A has a number-average molecular weight MW of 100,000 to 1,500,000 g/mol, preferably from 200,000 g/mol to 1,000,000 g/mol, more preferably 300,000 to 800,000 g/mol, even more preferably 400,000 to 700,000 g/mol and particularly preferably 500,000 to 600,000 g/mol.

In addition to component A, the film contains at least one further component B. According to the invention, component B is an aliphatic copolyester which is composed of at least one diol component and at least one dicarboxylic acid component. According to a preferred embodiment of the invention, component B is an aliphatic copolyester composed of at least one diol component and at least two dicarboxylic acid components.

According to the invention, the carbon skeleton of the diol component may be linear, branch-chained and/or cyclic. The diol component according to the invention has a chain length of at least two carbon atoms and at most twelve carbon atoms. A chain length of two to six carbon atoms is preferred. Preferably, the diol component is selected from a group consisting of 1,2-ethanediol, 1,2-propanediol, 1,3-propanediol, 1,2-butanediol, 1,3-butanediol, 1,4-butanediol, 2,3-butanediol, 1,2-pentanediol, 1,3-pentanediol, 1,4-pentanediol, 1,5-pentanediol, 2,3-pentanediol, 2,4-pentanediol, 1,2-hexanediol, 1,3-hexanediol, 1,4-hexanediol, 1,5-hexanediol, 1,6-hexanediol, 2,3-hexanediol, 2,4-hexanediol, 2,5-hexanediol, 3,4-hexanediol, 1,2-cyclopentanediol, 1,3-cyclopentanediol, 1,2-cyclohexanediol, 1,3-cyclohexanediol, 1,4-cyclohexanediol, diethylene glycol, triethylene glycol and mixtures thereof. Diols selected from a group consisting of 1,2-ethanediol, 1,3-propanediol, 1,4-butanediol and mixtures thereof are particularly preferred as the diol component of component B according to the invention. 1,4-butanediol is very particularly preferred as the diol component.

According to the invention, the carbon skeleton of the dicarboxylic acid component may be linear, branched and/or cyclic; preferably, the carbon skeleton of the dicarboxylic acid component is linear. The dicarboxylic acid component according to the invention has a chain length of from two to twenty carbon atoms, preferably from four to twelve carbon atoms. Preferably, the dicarboxylic acid component is selected from a group consisting of succinic acid, adipic acid, sebacic acid, azelaic acid, 1,12-dodecanedioic acid and mixtures thereof. The dicarboxylic acid component according to the invention is particularly preferably selected from a group consisting of succinic acid, adipic acid, sebacic acid and mixtures thereof.

The aliphatic copolyester according to component B is preferably a thermoplastic aliphatic copolyester.

The diol and dicarboxylic acid components of component B according to the invention can be prepared chemically and/or biologically.

In a preferred embodiment of the invention, the aliphatic copolyester according to component B is polybutylene succinate or polybutylene adipate-co-succinate. A particularly preferred embodiment of the invention uses polybutylene adipate-co-succinate as component B.

Advantageously, the aliphatic copolyester according to component B has a number-average molecular weight MW of 50,000 to 500,000 g/mol, preferably from 70,000 to 400,000 g/mol, more preferably from 90,000 to 300,000 g/mol, particularly preferably from 100,000 to 200,000 g/mol.

The film according to the invention may contain further polymeric components in addition to components A and B. In particular, in addition to the components A and B, the film according to the invention may comprise poly(butylene adipate-co-terephthalate) (PBAT) or poly(butylene sebacate-co-terephthalate) (PBST) or mixtures thereof.

According to one embodiment, the film comprises 0.1 to 30 wt. %, preferably 1 to 25 wt. %, more preferably 3 to 20 wt. %, even more preferably 4 to 15 wt. %, particularly preferably 5 to 12 wt. %, poly(butylene adipate-co-terephthalate) and/or poly(butylene sebacate-co-terephthalate) (PBST). According to a further embodiment, the film comprises 15 to 25 wt. %, preferably 17 to 23 wt. %, particularly preferably 18 to 22 wt. %, poly(butylene adipate-co-terephthalate) and/or poly(butylene sebacate-co-terephthalate) (PBST).

As a further constituent, the film according to the invention may contain 0.1 to 20 wt. %, preferably 2 to 18 wt. %, more preferably 5 to 15 wt. %, particularly preferably 8 to 12 wt. %, starch.

Thermoplastic starch, denatured starch and/or starch derivatives, inter alia, can be used as starch according to the invention. Preferably, thermoplastic starch can be used.

For many applications, it is advantageous if the film has a total thickness of from 5 to 200 μm, preferably from 10 to 80 μm, particularly preferably from 15 to 60 μm. The film is suitable in different thicknesses for the production of different products. Films in the thicknesses mentioned are particularly suitable for the production of carrier bags and transport bags for everyday use.

The mechanical properties and the biodegradability of the film according to the invention are primarily determined by the ratio of components A and B.

The film according to the invention contains 10 to 90 wt. % of a component A, based on the sum of the components A and B. According to a preferred embodiment of the invention, the film contains preferably 20 to 80 wt. %, particularly preferably 25 to 75 wt. %, of component A based on the sum of components A and B.

The film according to the invention contains 10 to 90 wt. % of a component B, based on the sum of the components A and B. In a preferred embodiment of the invention, the film contains preferably 20 to 80 wt. %, particularly preferably 25 to 75 wt. %, of component B, based on the sum of components A and B.

According to a preferred embodiment of the invention, the film contains 10 to 50 wt. %, preferably 20 to 40 wt. %, more preferably 25 to 40 wt. %, even more preferably 25 to 35 wt. % and particularly preferably 28 to 32 wt. %, of component A, based on the sum of components A and B. According to this embodiment, the film further contains preferably 50 to 90 wt. %, more preferably 60 to 80 wt. %, even more preferably 60 to 75 wt. %, still more preferably 65 to 75 wt. %, and particularly preferably 68 to 72 wt. %, of component B, based on the sum of components A and B.

According to a further preferred embodiment of the invention, the film contains 10 to 50 wt. %, preferably 20 to 40 wt. %, more preferably 25 to 40 wt. %, even more preferably 25 to 35 wt. % and particularly preferably 28 to 32 wt. %, of component B, based on the sum of components A and B. According to this embodiment, the film further contains preferably 50 to 90 wt. %, more preferably 60 to 80 wt. %, even more preferably 60 to 75 wt. %, still more preferably 65 to 75 wt. %, and particularly preferably 68 to 72 wt. %, of component A, based on the sum of components A and B.

When a component B is mentioned here or elsewhere, this component B may consist of one compound and/or a plurality of compounds. In a preferred embodiment of the invention, component B consists of a single compound. In a further preferred embodiment of the invention, the component B consists of a plurality of different compounds, in particular of two or three different compounds.

The film according to the invention is characterized by excellent mechanical properties, which allows the use thereof in transport bags.

The film according to the invention therefore preferably has an elongation at tear in the extrusion direction (MD, machine direction), according to EN ISO 527, of at least 100% in the dry state. In a preferred embodiment of the invention, the elongation at tear in the extrusion direction (MD), according to EN ISO 527, is at least 150%, preferably at least 200%, more preferably at least 300%, particularly preferably at least 400%.

Furthermore, the film according to the invention preferably has an elongation at tear transversely to the direction of extrusion (TD, transverse direction), according to EN ISO 527, of at least 100% in the dry state. In a preferred embodiment of the invention, the elongation at tear transversely to the extrusion direction (TD), according to EN ISO 527, is at least 150%, preferably at least 200%, more preferably at least 300%, particularly preferably at least 400%.

In addition, the film according to the invention preferably has a tensile strength in the extrusion direction (MD) of at least 15 MPa, according to EN ISO 527, in the dry state. According to a preferred embodiment of the invention, the tensile strength in the direction of extrusion (MD) of the film is at least 20 MPa, preferably at least 25 MPa, particularly preferably at least 30 MPa, in the dry state.

In addition, the film according to the invention preferably has a tensile strength transversely to the extrusion direction (TD) of at least 15 MPa, according to EN ISO 527, in the dry state. According to a preferred embodiment of the invention, the tensile strength transversely to the direction of extrusion (TD) of the film is at least 20 MPa, preferably at least 25 MPa, particularly preferably at least 30 MPa, in the dry state.

Advantageously, the film has a dart drop value in the dry state of at least 4 g/μm, preferably of at least 5 g/μm, particularly preferably of at least 6 g/μm, according to the method ASTM D1709.

The film according to the invention is characterized not only by the excellent mechanical properties but also by very good biodegradability and rapid decomposition in salt water.

Therefore, after introduction into salt water for a period of 12 weeks under controlled test conditions, according to the method ASTM D6691-09, and after sieving through a sieve having a mesh size of 2.0 mm, the film according to the invention preferably has a maximum of 30 wt. % of the original dry weight.

In a preferred embodiment of the invention, after introduction into salt water for a period of 12 weeks under controlled test conditions, according to the method ASTM D6691-09, and after sieving through a sieve having a mesh size of 2.0 mm, the film has a maximum of 20 wt. %, preferably a maximum of 10 wt. %, of the original dry weight.

The term salt water refers here to a natural seawater medium according to point 7.5.2 of the method ASTM D6691-09.

When the method ASTM D6691-09 is mentioned here or elsewhere, this is intended to mean the version issued on 15 Nov. 2009 having the title “Standard Test Method for Determining Aerobic Biodegradation of Plastic Materials in the Marine Environment by a Defined Microbial Consortium or Natural Sea Water Inoculum.”

The film according to the invention has excellent biodegradability in salt water. At least 30% of the organic carbon of the film according to the invention is preferably converted to carbon dioxide within 180 days at a temperature of 30±2° C., according to the method ASTM D6691-09, after introduction of the film into salt water.

In a preferred embodiment of the invention, after introduction of the film into salt water for 180 days at a temperature of 30±2° C. under controlled test conditions, according to the method ASTM D6691-09, preferably at least 40%, particularly preferably at least 50%, of the organic carbon of the film is converted to carbon dioxide. The term salt water refers here to a natural seawater medium according to point 7.5.2 of the method ASTM D6691-09.

The biodegradation of the film according to the invention is exceptionally effective not only in the natural conditions of seawater. In a preferred embodiment of the invention, preferably at least 70%, more preferably at least 80%, particularly preferably at least 90%, of the organic carbon of the film is converted to carbon dioxide within 180 days in active degradation conditions according to the method DIN EN ISO 14855-1:2012.

The biological degradation of the film in seawater usually takes place in two steps, which begin either simultaneously or at different times. On the one hand, the film according to the invention decomposes in seawater into smaller parts (“fragmentation”). On the other hand, the plastic parts are biodegraded at the molecular level by being converted by microorganisms to carbon dioxide and water (“biodegradation”). Frequently, but not necessarily, the “fragmentation” step begins before the “biodegradation” step.

The film according to the invention may be formed as a single-layer or multi-layer film. The film according to the invention is preferably designed as a single-layer film, since a single-layer film can be produced in a particularly simple and cost-effective manner and can be further processed to form transport bags. However, it is also possible for the film according to the invention to comprise one or more identical or different additional layers. The individual layers of a multi-layer film may, for example, differ from one another in terms of their composition and their thickness.

The film according to the invention may contain, in addition to the constituents mentioned, further constituents.

The film according to the invention may further contain, for example, plasticizers. Examples of plasticizers are glycerol, sorbitol, arabinose, lycose, xylose, glucose, fructose, mannose, allose, altrose, galactose, gulose, iodose, inositol, sorbose, talitol and monoethoxylate, monopropoxylate and monoacetate derivatives thereof, and ethylene, ethylene glycol, propylene glycol, ethylene diglycol, propylene diglycol, ethylene triglycol, propylene triglycol, polyethylene glycol, polypropylene glycol, 1,2-propanediol, 1,3-propanediol, 1,2-, 1,3-, 1,4-butanediol, 1,5-pentanediol, 1,6-, 1,5-hexanediol, 1,2,6-, 1,3,5-hexanetriol, neopentyl glycol, trimethylopropane, pentaerythritol, sorbitol and the acetate, ethoxylate and propoxylate derivatives and mixtures thereof.

Preferably, the film according to the invention is free of oligomeric ester compounds having a weight-average molecular weight of 500 to 5000 g/mol, in particular poly(1,3-butylene glycol-co-1,2-propylene glycol adipic acid) terminated with 2-ethylhexanol, poly(neopentylglycol-co-1,4-butylene glycol adipic acid) terminated with 2-ethylhexanol, poly(1,3-butylene glycol adipic acid) non-terminated, poly(1,2-propylene glycol adipic acid-co-phthalic acid) terminated with 2-ethylhexanol, poly(neopentyl glycol adipic acid) terminated with 2-ethylhexanol, poly(1,2-propylene glycol adipic acid-co-phthalic acid) terminated with 2-ethylhexanol, poly(1,3-butylene glycol adipic acid) terminated with mixed fatty acids, poly(1,2-propylene glycol adipic acid) terminated with 2-ethylhexanol, poly(1,2-propylene glycol-co-1,4-butylene glycol adipic acid) terminated with 2-ethylhexanol, poly(1,4-butylene glycol adipic acid) or poly(1,4-butylene glycol-co-ethylene glycol adipic acid), each having a weight-average molecular weight of 500 to 5000 g/mol.

Furthermore, the film according to the invention may contain dispersing aids such as detergents, melt stabilizers, processing aids, stabilizers, antioxidants, flame retardants, anti-blocking agents, fillers and/or additives.

In addition, the film according to the invention may additionally contain other polymers such as, for example, polyethylene glycol, polyvinyl alcohol, chitin, chitosan, cellulose, cellulose derivatives, polyesters, polydimethylaminoethyl methacrylate, and mixtures thereof.

According to a further preferred embodiment of the invention, the film according to the invention contains one or more fillers and/or one or more disintegrants. Depending on the type and amount of filler and/or disintegrant, the rate of disintegration of the film according to the invention can be influenced.

Preferred fillers for this purpose are selected from the group consisting of calcium carbonate, talc, kaolin, dolomite, mica, silicic acid, and mixtures thereof.

Disintegrants are known to a person skilled in the art. Preferred disintegrants for this purpose are selected from the group consisting of sodium hydrogen-carbonate, alginic acid, calcium alginate, sodium alginate, microcrystalline cellulose, sodium carboxymethyl cellulose, starch, sodium carboxymethyl starch, polyvinyl pyrrolidone, and mixtures thereof. Starch can be native or destructured.

The invention further relates to the use of a polymer blend containing component A and component B for producing a film having a total thickness of from 1 to 200 μm and at least one of the following mechanical properties:
tensile strength in the dry state in the extrusion direction (MD) of at least 15 MPa according to EN ISO 527;
tensile strength in the dry state transversely to the extrusion direction (TD) of at least 15 MPa according to EN ISO 527;
elongation at tear in the dry state in the extrusion direction (MD) of at least 100% according to EN ISO 527;
elongation at tear in the dry state transversely to the extrusion direction (TD) of at least 100% according to EN ISO 527;

and the film having a maximum of 30 wt. % of the original dry weight after introduction into salt water for a period of 12 weeks under controlled test conditions, according to the method ASTM D6691-09, and after sieving through a sieve having a mesh size of 2.0 mm, and/or at least 30% of the organic carbon of the film being converted to carbon dioxide within 180 days at a temperature of 30±2° C., according to the method ASTM D6691-09, after introduction into salt water.

The statements made with regard to components A and B of the film according to the invention apply to components A and B, respectively, of the use according to the invention.

The polymer blend preferably contains 10-90 wt. %, in particular 20 to 80 wt. % or 25 to 75 wt. %, of component A, based on the sum of the components A and B. Furthermore, the polymer blend preferably contains 10-90 wt. %, in particular 20 to 80 wt. % or 25 to 75 wt. % of component B, based on the sum of components A and B.

According to a preferred embodiment of the invention, the polymer blend contains 10 to 50 wt. %, preferably 20 to 40 wt. %, more preferably 25 to 40 wt. %, even more preferably 25 to 35 wt. % and particularly preferably 28 to 32 wt. %, of component A, based on the sum of components A and B.

According to this embodiment, the polymer blend further contains preferably 50 to 90 wt. %, more preferably 60 to 80 wt. %, even more preferably 60 to 75 wt. %, still more preferably 65 to 75 wt. %, and particularly preferably 68 to 72 wt. %, of component B, based on the sum of components A and B.

According to a further preferred embodiment of the invention, the polymer blend contains 10 to 50 wt. %, preferably 20 to 40 wt. %, more preferably 25 to 40 wt. %, even more preferably 25 to 35 wt. % and particularly preferably 28 to 32 wt. %, of component B, based on the sum of components A and B.

According to this embodiment, the polymer blend further contains preferably 50 to 90 wt. %, more preferably 60 to 80 wt. %, even more preferably 60 to 75 wt. %, still more preferably 65 to 75 wt. %, and particularly preferably 68 to 72 wt. %, of component A, based on the sum of components A and B.

Furthermore, the polymer blend may contain one or more of the above-mentioned constituents.

The invention also relates to products which are or can be produced using the film according to the invention.

Transport bags which are or can be produced from the film according to the invention are of particular significance. The films according to the invention are suitable for the production of transport bags of any kind, including carrier bags, fruit bags, vegetable bags, light T-shirt bags and ultra-light T-shirt bags.

The different types of transport bags may have a different weight depending on the application. In a preferred embodiment of the invention, a transport bag according to the invention, for example, has a weight of preferably 1 to 90 g, more preferably 2 to 50 g or particularly preferably 20 to 40 g. Transport bags according to the invention which have a weight of preferably 1 to 10 g, more preferably 1.5 to 5 g, are particularly suitable for other applications.

Finally, the invention also relates to a method for producing a film. The process according to the invention for producing a film comprises at least the following steps:
a. providing a polymer blend containing component A and component B;
b. forming a film from the polymer blend according to step a.

Suitable methods for forming a film according to step b. are well known to a person skilled in the art and typically include an extrusion step (in particular a coextrusion step) and/or a lamination step.

The statements made with regard to components A and B of the film according to the invention apply to components A and B, respectively, of the method according to the invention.

The polymer blend preferably contains 10-90 wt. %, in particular 20 to 80 wt. % or 25 to 75 wt. %, of component A, based on the sum of the components A and B. Furthermore, the polymer blend preferably contains 10-90 wt. %, in particular 20 to 80 wt. % or 25 to 75 wt. % of component B, based on the sum of components A and B.

According to a preferred embodiment of the method according to the invention, the polymer blend contains 10 to 50 wt. %, preferably 20 to 40 wt. %, more preferably 25 to 40 wt. %, even more preferably 25 to 35 wt. % and particularly preferably 28 to 32 wt. %, of component A, based on the sum of components A and B. According to this embodiment, the polymer blend further contains preferably 50 to 90 wt. %, more preferably 60 to 80 wt. %, even more preferably 60 to 75 wt. %, still more preferably 65 to 75 wt. %, and particularly preferably 68 to 72 wt. %, of component B, based on the sum of components A and B.

According to a further preferred embodiment of the method according to the invention, the polymer blend contains 10 to 50 wt. %, preferably 20 to 40 wt. %, more preferably 25 to 40 wt. %, even more preferably 25 to 35 wt. % and particularly preferably 28 to 32 wt. %, of component B, based on the sum of components A and B. According to this embodiment, the polymer blend further contains preferably 50 to 90 wt. %, more preferably 60 to 80 wt. %, even more preferably 60 to 75 wt. %, still more preferably 65 to 75 wt. %, and particularly preferably 68 to 72 wt. %, of component A, based on the sum of components A and B.

Furthermore, the polymer blend may contain one or more of the above-mentioned constituents.

The invention is explained in greater detail in the following with reference to practical examples.

### EXAMPLES

The following materials were used for the comparative and practical examples: poly(butylene succinate-co-adipate), PBSA (BioPBS FD92PM, PTT MCC Biochem Company Limited); poly(hydroxybutyrate-co-hexanoate), PHBH (AONILEX 151N, KANEKA); erucic acid amide (LOXIOL E SPEZ P, Emery Oleochemicals).

### Example 1

Using a twin screw extruder of the type Coperion ZSK 40 (twin-screw compounder), screw diameter 40 mm, L/D=42, a polymer blend was prepared with the formulation A given in Table 1 and processed to form a granulate (metered proportions in mass percentage):

TABLE 1
Formulation A

| Compound | Amount |
|---|---|
| PHBH | 29.7 |
| PBSA | 69.3 |
| Loxiol | 1 |

The following compounding parameters were observed:

TABLE 2
Temperature profile (twin screw extruder ZSK 40)

| Zone | Zone | Zone | Zone | Zone | Zone | Zone | Zone | Zone | Zone | |
|---|---|---|---|---|---|---|---|---|---|---|
| 1 | 2 | 3 | 4 | 5 | 6 | 7 | 8 | 9 | 10 | Nozzle |
| 25° C. | 105° C. | 120° C. | 120° C. | 135° C. | 155° C. | 165° C. | 165° C. | 165° C. | 160° C. | 160° C. |

| | | |
|---|---|---|
| Speed | 100 | min⁻¹ |
| Flow rate | 50 | kg/h |

| | |
|---|---|
| Degassing | −0.98 bar, zone 8 |
| Water content | 0.1% |

Blown films were produced from the granulate produced. For this purpose, the granulate A was melted using a single-screw extruder of the type KABRA, screw diameter 65 mm, L/D=23, and processed to form a blown film.

In order to investigate the durability of the film in water, samples of the film were clamped in slide frames and placed in natural seawater. The decomposition of the film was examined visually. Table 3 documents the relative decomposition of the film over a period of 72 days in seawater.

TABLE 3
Relative decomposition of the film obtainable from granulate A

| Days | Decomposition |
|---|---|
| 0 | 1 |
| 22 | 1 |
| 37 | (3)-4 |
| 72 | 4 |

Legend:

| Value | Meaning |
|---|---|
| 1 | Foil intact |
| 2 | Decomposition visible |
| 3 | Decomposition advanced |
| 4 | Film completely decomposed |

In addition, the mechanical properties of the film were checked. The tensile strength and elongation at tear were measured on a Tinius Olsen universal testing machine H10KS. In order to determine the film thickness, the precision thickness gauging device DM 2000 from Wolf-Messtechnik was used. The results of the measurements are listed in Table 4.

TABLE 4
Mechanical properties of the film

| Film | Tensile | Tensile | Elongation | Elongation |
|---|---|---|---|---|
| thickness | strength | strength | at tear | at tear |
| [μm] | (MD) [MPa] | (TD) [MPa] | (MD) [%] | (TD) [%] |
| 25-30 | 39.1 | 35.5 | 665 | 816 |

As can be seen from Tables 3 and 4, the film has excellent mechanical properties for use as a transport bag and very good decomposition in seawater. After just over a month in seawater, the film decomposed almost completely (Table 3, line 3).

### Example 2

Using a twin screw extruder of the type Coperion ZSK 40 (twin-screw compounder), screw diameter 40 mm, L/D=42, a polymer blend was prepared with the formulation B given in Table 5 and processed to form a granulate (metered proportions in mass percentage):

TABLE 5
Formulation B

| Compound | Amount |
|---|---|
| PHBH | 69.3 |
| PBSA | 29.7 |
| Loxiol | 1 |

The following compounding parameters were observed:

TABLE 6
Temperature profile (twin screw extruder ZSK 40)

| Zone | Zone | Zone | Zone | Zone | Zone | Zone | Zone | Zone | Zone | |
|---|---|---|---|---|---|---|---|---|---|---|
| 1 | 2 | 3 | 4 | 5 | 6 | 7 | 8 | 9 | 10 | Nozzle |
| 25° C. | 105° C. | 120° C. | 120° C. | 135° C. | 155° C. | 165° C. | 165° C. | 165° C. | 160° C. | 160° C. |

| | | |
|---|---|---|
| Speed | 100 | min⁻¹ |
| Flow rate | 50 | kg/h |

| | |
|---|---|
| Degassing | −0.98 bar, zone 8 |
| Water content | 0.1% |

Blown films were produced from the granulate produced. For this purpose, the granulate B was melted using a single-screw extruder of the type KABRA, screw diameter 65 mm, L/D=23, and processed to form a blown film.

Table 7 documents the relative decomposition of the film over a period of 72 days in seawater.

TABLE 7
Relative decomposition of the film obtainable from granulate B

| Days | Decomposition |
|---|---|
| 0 | 1 |
| 22 | (2)-3 |
| 37 | 4 |
| 72 | 4 |

Legend:

| Value | Meaning |
|---|---|
| 1 | Foil intact |
| 2 | Decomposition visible |
| 3 | Decomposition advanced |
| 4 | Film completely decomposed |

The mechanical properties of the film were checked. The measurement was carried out using the same apparatuses as in Example 1. The results of the measurement are listed in Table 8.

TABLE 8
Mechanical properties of the film

| Film | Tensile | Tensile | Elongation | Elongation |
|---|---|---|---|---|
| thickness | strength | strength | at tear | at tear |
| [μm] | (MD) [MPa] | (TD) [MPa] | (MD) [%] | (TD) [%] |
| 20-55 | 25.3 | 23.9 | 475 | 544 |

As can be seen from Tables 7 and 8, the film made of granulate B has a good combination of degradability in seawater and mechanical properties for use as a transport bag.

1. A film comprising
10-90 wt. % of a component A and 10-90 wt. % of a component B, based on the sum of the components A and B,
wherein A is a polyhydroxyalkanoate,
wherein B is an aliphatic copolyester composed of at least one diol component and at least one dicarboxylic acid component, and
wherein the film has a total thickness of 1 to 200 μm.

2. The film according to claim 1, wherein the film has at least one of the following mechanical properties:
a tensile strength of the film in the dry state in the extrusion direction (MD) of at least 15 MPa according to EN ISO 527;
a tensile strength of the film in the dry state transversely to the extrusion direction (TD) of at least 15 MPa according to EN ISO 527;
an elongation at tear of the film in the dry state in the extrusion direction (MD) of at least 100% according to EN ISO 527; or
an elongation at tear of the film in the dry state transversely to the extrusion direction (TD) of at least 100% according to EN ISO 527.

3. The film according to claim 1, wherein after introduction into salt water for a period of 12 weeks under controlled test conditions, according to the method ASTM D6691-09, and after sieving through a sieve having a mesh size of 2.0 mm, the film has a maximum of 30 wt. % of the original dry weight, and/or wherein after introduction into salt water, at least 30% of the organic carbon of the film is converted to carbon dioxide within 180 days at a temperature of 30±2° C., according to the method ASTM D6691-09.

4. The film according to claim 1, wherein component A is selected from the group consisting of poly(3-hydroxybutanoate), poly(3-hydroxyvalerate), poly(3-hydroxyhexanoate), poly(3-hydroxybutyrate-co-3-hydroxyvalerate), poly(3-hydroxybutyrate-co3-hexanoate), and mixtures thereof.

5. The film according to claim 4, wherein component A is poly(3-hydroxybutyrate-co-3-hexanoate).

6. The film according to claim 4, wherein component A has a number-average molecular weight of 100,000 to 1,500,000 g/mol, or 200,000 to 1,000,000 g/mol, or 300,000 to 800,000 g/mol, or 400,000 to 700,000 g/mol, or 500,000 to 600,000 g/mol.

7. The film according to claim 1, wherein component B is an aliphatic copolyester composed of at least one diol component and at least two dicarboxylic acid components.

8. The film according to claim 7, wherein component B is poly(butylene adipate-co-succinate).

9. The film according to claim 7, wherein component B has a number-average molecular weight of 50,000 to 500,000 g/mol, or 70,000 to 400,000 g/mol, or 90,000 to 300,000 g/mol, or 100,000 to 200,000 g/mol.

10. The film according to claim 1, wherein the film comprises 0.1 to 30 wt. %, or 1 to 25 wt. %, or 3 to 20 wt. %, or 4 to 15 wt. %, or 5 to 12 wt. %, or 15 to 25 wt. %, or 17 to 23 wt. %, or 18 to 22 wt. % poly(butylene adipate-co-terephthalate), based on the total weight.

11. The film according to claim 1, wherein the film comprises 0.1 to 30 wt. %, or 1 to 25 wt. %, or 3 to 20 wt. %, or 4 to 15 wt. %, or 5 to 12 wt. %, or 15 to 25 wt. %, or 17 to 23 wt. %, or 18 to 22 wt. % poly(butylene sebacate-co-terephthalate), based on the total weight.

12. The film according to claim 1, wherein the film comprises 0.1 to 30 wt. %, or 1 to 25 wt. %, or 3 to 20 wt. %, or 4 to 15 wt. %, or 5 to 12 wt. %, or 15 to 25 wt. %, or 17 to 23 wt. %, or 18 to 22 wt. % polycaprolactone, based on the total weight.

13. The film according to claim 1, wherein the film comprises 0.1 to 20 wt. %, or 2 to 18 wt. %, or 5 to 15 wt. % or 8 to 12 wt. % starch or thermoplastic starch, based on the total weight.

14. The film according to claim 1, wherein the film has a total thickness of 5 to 200 μm, or 10 to 80 μm or 15 to 60 μm.

15. The film according to claim 1, wherein the film comprises 20 to 80 wt. %, or 25 to 75 wt. %, of component A, based on the sum of components A and B.

16. The film according to claim 1, wherein the film comprises 20 to 80 wt. %, or 25 to 75 wt. %, of component B, based on the sum of components A and B.

17. The film according to claim 1, wherein the film has a tensile strength in the dry state in the extrusion direction (MD) of at least 20 MPa, or at least 25 MPa, according to EN ISO 527.

18. The film according to claim 1, wherein the film has a tensile strength in the dry state transversely to the extrusion direction (TD) of at least 20 MPa, or at least 25 MPa, according to EN ISO 527.

19. The film according to claim 1, wherein the film has an elongation at tear in the dry state in the extrusion direction (MD) of at least 200%, or at least 300% or at least 400%, according to EN ISO 527.

20. The film according to claim 1, wherein the film has an elongation at tear in the dry state transversely to the extrusion direction (TD) of at least 200%, or at least 300% or at least 400%, according to EN ISO 527.

21. The film according to claim 1, wherein after introduction into salt water, at least 40%, or at least 50%, of the organic carbon of the film is converted to carbon dioxide within 180 days at 30±2° C., according to the method ASTM D6691-09.

22. The film according to claim 1, wherein after introduction into salt water for a period of 12 weeks under controlled test conditions, according to the method ASTM D6691-09, and after sieving through a sieve having a mesh size of 2.0 mm, the film has a maximum of 20 wt. %, or a maximum of 10 wt. %, of the original dry weight.

23. The film according to claim 1, wherein in active decomposition conditions according to the method DIN EN ISO 14855-1:2012, at least 70%, or at least 80%, or at least 90% of the organic carbon of the film was converted into carbon dioxide within 180 days.

24. (canceled)

25. (canceled)

26. (canceled)

27. A transport bag comprising a film according to claim 1.

28. The transport bag according to claim 27, characterized in that the transport bag is selected from the group consisting of carrier bag, fruit bag, vegetable bag, light T-Shirt bag and ultra-light T-Shirt bag.

29. The transport bag according to either-claim 27, wherein the transport bag has a weight of 1 to 90 g, or 2 to 50 g, or 20 to 40 g, or 1 to 10 g or 1.5 to 5 g.

30. A method for producing a film according to claim 1, comprising the following steps:
a. providing a polymer blend containing component A and component B; and
b. forming a film from the polymer blend according to step a.

31. The method according to claim 30, characterized in that the method comprises a coextrusion step.

32. The method according to claim 30, wherein the method comprises a lamination step.

33. The method according to claim 30, wherein component A is selected from the group consisting of poly(3-hydroxybutanoate), poly(3-hydroxyvalerate), poly(3-hydroxyhexanoate), poly(3-hydroxybutyrate-co-3-hydroxyvalerate), poly(3-hydroxybutyrate-co3-hexanoate), and mixtures thereof and/or component B is an aliphatic copolyesters composed of at least one diol component and at least two dicarboxylic acid components.

34. The method according to claim 30, wherein the polymer blend contains 10-90 wt. %, or 20 to 80 wt. %, or 25 to 75 wt. %, of component A, based on the sum of components A and B, and/or 10-90 wt. %, or 20 to 80 wt. %, or 25 to 75 wt. %, of component B, based on the sum of components A and B.
